(19) United States
(12) Patent Application Publication
(10) Pub. No.: US 2023/0024391 A1
(43) Pub. Date: Jan. 26, 2023

(54) SHANK AND CUTTING TOOL HAVING THE SHANK

(71) Applicant: TUNGALOY CORPORATION, Fukushima (JP)

(72) Inventors: Hiroki SHIMANUKI, Iwaki-shi (JP); Jun OTSUKA, Iwaki-shi (JP)

(73) Assignee: TUNGALOY CORPORATION, Fukushima (JP)

(21) Appl. No.: 17/853,306

(22) Filed: Jun. 29, 2022

(30) Foreign Application Priority Data
Jul. 20, 2021 (JP) 2021-119281

(51) Int. Cl. B23B 27/04

(52) U.S. Cl. CPC B23B 27/04

(57) ABSTRACT

A shank for a tool bit employing an offset arrangement is provided, the shank being able to respond to various types of machining through replacement of heads and having a structure to save time and steps necessary for such replacement of the heads. A cutting tool having such shank is also provided.

A shank 53 of a head-replaceable cutting tool has at least one head attaching part 53A, 53B that is arranged off-center relative to an axis 53X of the shank 53. The axis 53X of the shank 53 corresponds to an axis extending in a longitudinal direction of the shank 53, and the head attaching part 53A, 53B may be arranged so as to be off-center in a direction perpendicular to the axis 53X.

### CROSS-REFERENCES TO RELATED APPLICATIONS

This application relates to and claims priority from Japanese Patent Application No. 2021-119281, filed on Jul. 20, 2021, the entire disclosure of which is incorporated herein by reference.

### BACKGROUND

### Field

The present invention relates to a shank and a cutting tool having such shank.

### Description of Related Art

In a conventional automatic lathe for automatically turning, a long-length workpiece is fed in a Z-axis direction while the cutting tool is moved along an axis perpendicular to the Z-axis direction (such axis perpendicular to the Z-axis corresponds to, for example, an axis in the longitudinal direction of the holder and the axis will hereinafter be referred to as the “X-axis” for convenience of explanation) and, as a result, the workpiece is turned and is cut into a three-dimensional shape. A small-sized head-replaceable cutting tool that can be used for this type of automatic lathe is typically structured such that the shank of the tool and the part to which a head is attached (“head attaching part”) are arranged in a coaxial manner (see, for example, JP2017-047527 A).

### SUMMARY

When such conventional shank for a head-replaceable cutting tool is used for machining, such as screw-thread machining, where the machining length (i.e., the length of a portion of a workpiece to be machined) is longer than the length between a guide bush for guiding the workpiece and a cutting edge of the cutting tool (such length will hereinafter be called a “machinable length”), the shank may cause the problem of damaging the guide bush due to burrs. One reason for this problem is that the head position cannot be changed even if there is a variation in machining length. In view of the above, employing, for example, a turning tool with a stepped head in which the shank is configured to have a step (an offset portion) in the Z-axis direction so as to change the position of the head according to a different machining length, can be a measure to respond to the above-described problem. In this connection, some conventional automatic lathes may be arranged such that the cutting part (i.e., a leading end portion on which an insert is mounted) is off-center (offset) relative to the shank in order to increase the machinable length. However, in order to implement this arrangement while using a conventional stepped head-type holder, it is necessary to exchange the entire holder every time the head position needs to be changed, whereby considerable time and steps are required for replacement of the tools.

Under the above-described circumstances, an object of the present invention is to provide a shank for a turning tool employing an offset arrangement, the shank being able to respond to various types of machining through replacement of heads and having a structure to save time and steps necessary for such replacement of the heads, and to also provide a cutting tool having such shank.

According to an aspect of the present invention, a shank of a head-replaceable cutting tool is provided, the shank having at least one attaching part to which a head is attached, wherein the at least one attaching part is arranged at an off-center position relative to an axis of the shank.

With the shank of the above aspect, when a head is attached to such attaching part that is arranged at an off-center position, a cutting edge of a cutting insert mounted on the head can also be positioned off-center. Accordingly, it is possible to perform machining by changing the position of the head so as to appropriately set a machinable length depending on the mode of the machining.

In the shank of the above aspect, the axis of the shank may correspond to an axis that extends in a longitudinal direction of the shank, and the head attaching part may be arranged so as to be off-center in a direction perpendicular to such axis.

In the shank of the above aspect, the attaching part may be arranged so as to be off-center along a feeding direction of a workpiece, which is an object to be cut, relative to an axis that extends in a longitudinal direction of the shank.

In the shank of the above aspect, a plurality of attaching parts may be arranged.

In the shank of the above aspect, a plurality of attaching parts may be arranged along a direction in which the at least one attaching part is arranged off-center.

In the shank of the above aspect, one of the plurality of attaching parts may be arranged at a position on the axis of the shank.

The shank of the above aspect may have an oil hole which is provided close to the attaching part and configured to discharge cutting oil toward the head attached to the attaching part.

In the shank of the above aspect, the oil hole may be provided on a surface where the attaching part is arranged, at a portion other than the attaching part.

According to another aspect of the present invention, a cutting tool having the above-described shank is provided.

### BRIEF DESCRIPTION OF DRAWINGS

FIG. 1 is a perspective illustration showing an example of a shank according to a first embodiment of the present invention, in which a head attaching part is arranged so as to be off-center relative to an axis of the shank.

FIG. 2 is a perspective illustration showing a state in which a cutting tool having a shank as shown in FIG. 1 is attached to a tool rest of an automatic lathe and a head is attached to the shank of the cutting tool.

FIG. 3 is a perspective illustration showing an example of a shank according to a second embodiment of the present invention, in which a plurality of head attaching parts are arranged.

FIG. 4 is a perspective illustration showing an example of a shank according to a third embodiment of the present invention, which is provided with an oil hole.

FIG. 5A is an illustration for explaining a modification of a shank.

FIG. 5B is a perspective illustration for explaining a modification of a shank.

FIG. 6 is a perspective illustration showing a state in which a workpiece is turned in an automatic lathe by feeding the workpiece in the Z-axis direction while moving the cutting tool along the X-axis perpendicular to the Z-axis.

### DETAILED DESCRIPTION

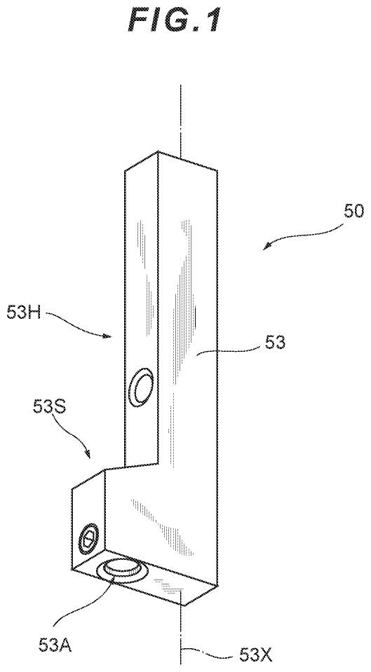

Hereinafter, preferred embodiments of a shank and a cutting tool having such shank according to the present invention will be described in detail, with reference to the attached drawings (see FIG. 1, etc.).

### First Embodiment

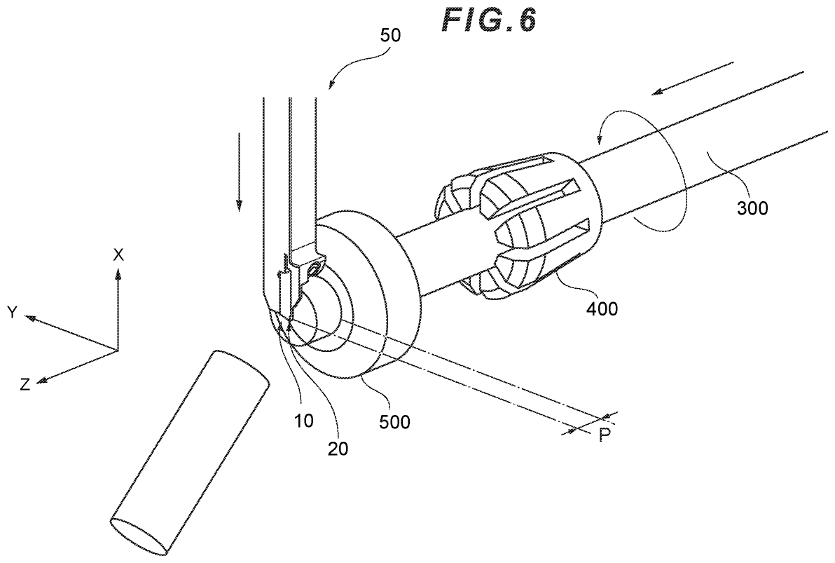

A cutting tool 1 is a tool for use in machining with an automatic lathe (not shown) and the like, and it is configured to cut a workpiece 300 by moving a cutting edge 20 of a cutting insert 10. In an automatic lathe for automatically turning, the long-length workpiece 300 is fed in a predetermined direction (which corresponds to the Z-axis direction in the present embodiment), while the cutting tool 1 is moved in a direction perpendicular to such feeding direction (in the present embodiment, the axis perpendicular to the Z-axis will be referred to as the X-axis for convenience of explanation) and, with this turning operation, the workpiece 300 is turned and is cut into a three-dimensional shape (see FIG. 6). Further, in such automatic lathe, a plurality of types of tool bits (holders) 50 may be placed on a tool rest 200 in a “comb-blade arrangement” and the tool rest 200 may be moved in the X-axis direction, or in the Y-axis direction which is perpendicular to both the X-axis and Z-axis directions, according to the mode of turning, thereby selecting, moving and exchanging the cutting insert 10 as appropriate so as to perform machining in an intended manner.

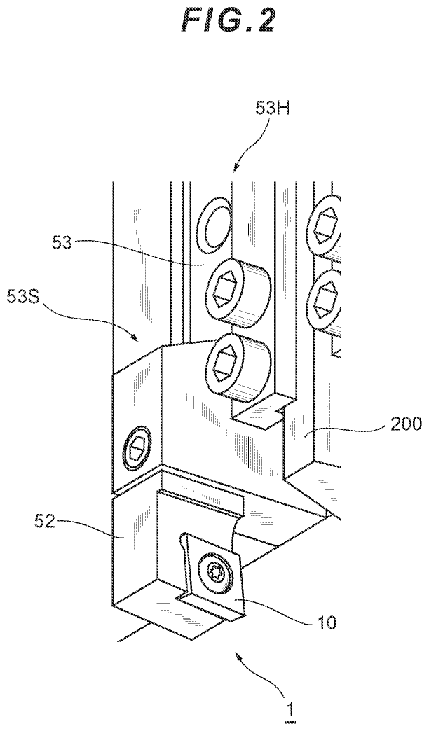

The cutting tool 1 according to the present embodiment, which is for use in such a manner of turning, is a head-replaceable cutting tool in which a head 52 is removable from a shank 53 of a tool bit 50. The shank 53 is attached to the tool rest 200 with its grip part 53H (in the shank 53 of the present embodiment, this corresponds to the main body part whose transverse section is constant) being gripped. The shank 53 is also provided with an attaching part 53A for attaching/detaching the head 52 (see FIG. 1, etc.). The head 52 is fixed to the shank 53 when, for example, a fastening screw (not shown) is fastened (laterally) from a side of the shank so that the fastening screw comes into contact with a part of the head 52. A cutting insert 10 having a predetermined cutting edge 20 is mounted on the head 52 (see FIG. 2).

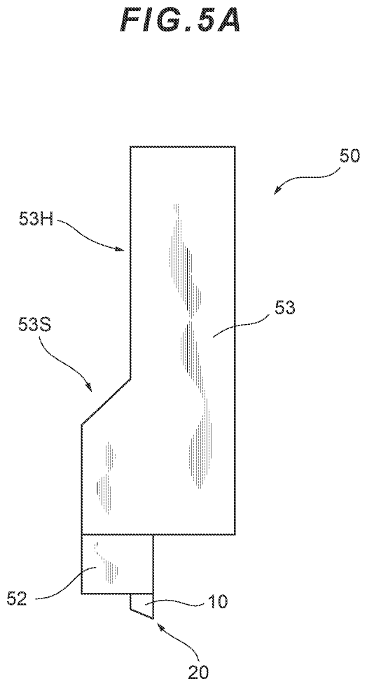

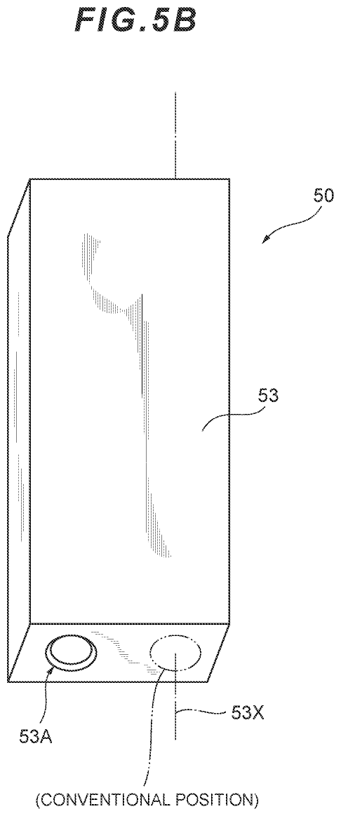

In the above-described head-replaceable cutting tool 1 according to the present embodiment, the structure of the shank 53 is specifically designed so as allow an off-center arrangement of the head 52. More specifically, the attaching part 53A for attaching the head is arranged at an off-center position relative to an axis 53X of the shank 53. The axis 53X of the shank 53, as referred to herein, indicates an axis extending along the longitudinal direction of the shank 53 and substantially passing through the center in a transverse section of the grip part 53H of the shank 53. Alternatively, in the case where an attaching part is arranged at a conventional or usual position in the shank 53, the axis 53X indicates an axis passing through the center of such attaching part at the conventional or usual position (see FIG. 5B). By assuming the axis 53X as described above, the attaching part 53A is arranged at a position displaced from the axis 53X, in other words, an off-center position relative to the axis 53X. The direction in which the attaching part is made off-center basically corresponds to the feeding direction of the workpiece 300 (i.e., the Z-axis direction); however, without being limited to this configuration, the attaching part may be arranged off-center in a diagonal direction, including displacement in the Z-axis direction.

Since the shank 53 has the above-described configuration, the position of the head 52 attached to the attaching part 53A that is arranged off-center, as well as the position of the cutting insert 10, can be automatically set off-center in accordance with the position of such off-center attaching part 53A, with the same amount of off-centering as that of the attaching part 53A. When the cutting insert 10 is placed at an off-center position, a machinable length (which refers to a length from a guide bush 500, which guides the workpiece 300, to the cutting edge of the cutting tool 1; see the length P shown in FIG. 6) also varies accordingly. As a result, a length P to the head position or the cutting edge can be appropriately changed to a suitable value for machining, in accordance with the machining length whose appropriate value can vary depending on the mode of the machining. Moreover, by changing the head 52, a machinable length according to the amount of off-centering can be set for various cutting inserts 10. With these configurations, it is possible to overcome the problem of the guide bush being damaged by burrs during cutting work involving a long machining length, such as a screw-thread cutting work.

In the present embodiment, in order to arrange the attaching part 53A at an off-center position as described above, the shank 53 is formed in a stepped shape (in other words, a hooked shape or an L-shape) in which a leading end portion in the X-axis of the shank 53 is bent toward the Z-axis direction (i.e., the feeding direction of the workpiece 300) (see FIGS. 1 and 2). In such bent portion of the shank 53, which is formed in a stepped shape (indicated by the reference sign 53S in FIG. 1, etc.), the attaching part 53A can be arranged so as to be off-center in the Z-axis direction (i.e., the feeding direction of the workpiece 300) relative to the axis 53X (see FIG. 1, etc.).

### Second Embodiment

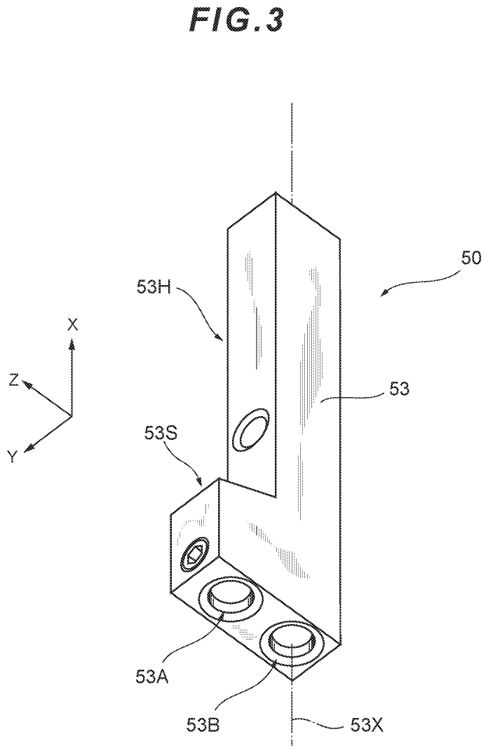

Regarding the attaching part in the above-described embodiment, a plurality of such attaching parts may be provided. As an example of such configuration, a shank 53 according to this embodiment has two attaching parts 53A and 53B arranged along the feeding direction of the workpiece 300 (i.e., in the Z-axis direction) (see FIGS. 3 and 5A). Similarly to the first embodiment, the shank 53 of this embodiment has a stepped portion 53S in which a leading-end portion of the shank 53 is bent in the Z-axis direction (i.e., the feeding direction of the workpiece 300). Such shank 53 having the stepped portion 53S obviously has a sufficient length (width) in its Z-axis direction for arranging a plurality of attaching parts (two attaching parts in this embodiment) (see FIGS. 3 and 5A).

With the shank 53 having the above-described configuration, a machinable length according to the amount of off-centering can be set for various cutting inserts 10 by only changing the head 52. Furthermore, when the attaching part 53A and attaching part 53B are provided based on the same specifications so as to allow the head 52 to be commonly used for both of them (in other words, the same type of head 52 can be attached/detached to/from both the attaching parts 53A and 53B), a variety of machinable lengths P can be set by preparing only several types of shanks 53 that correspond to different off-centering amounts, without the need to increase new variations of heads 52.

In this regard, when attempting to locate the cutting part (i.e., the cutting edge 20 of the cutting insert 10) at an off-center position in the head-replaceable cutting tool 1, such off-center arrangement may be achieved by modifying the configuration of the head 52 while leaving the coaxial placement between the shank 53 and the head 52 unchanged. In that case, the shank 53 can be basically of a single type only; however, a wide variety of heads 52 need to be prepared so as to provide different amounts of off-centering and respond to various shapes of inserts. In contrast, when such off-center arrangement is achieved by modifying the configuration of the shank 53, the head 52 can be commonly used and there is no need to increase new variations of the heads. In other words, it is only necessary to prepare several types of shanks 53 according to the desired amounts of off-centering, and this can be an advantage of this configuration.

When a plurality of attaching parts (e.g., two attaching parts in this embodiment) are provided as described above, one of the attaching parts (e.g., attaching part 53B) may be arranged at a position on the axis 53X (see FIG. 3, etc.). The attaching part 53B provided in this manner has the same configuration as that of a conventional attaching part in which the amount of off-centering is almost zero. Accordingly, such attaching part 53B can be used to respond to a cutting operation which is to be performed in a manner to maintain cutting precision by using a conventional type of shank. Thus, there is no need to exchange and use different shanks.

### Third Embodiment

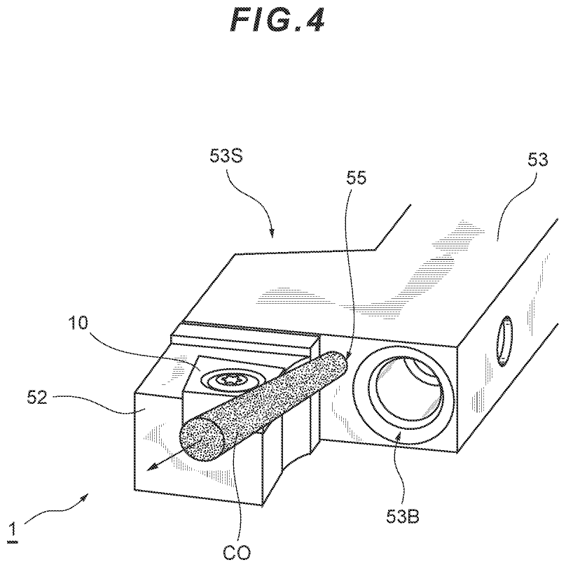

A shank 53 according to this embodiment has an oil hole 55 for discharging cutting oil (indicated by the reference sign CO in FIG. 4). The oil hole 55 corresponds to an outlet or a supply port of a flow path (not shown) that is provided inside the shank 53 for supplying the cutting oil CO. The oil hole 55 is configured so that the cutting oil CO is discharged through the oil hole 55 toward the head 52 attached to the attaching part (53A or 53B) or toward the cutting insert 10 on the head 52 (see FIG. 4). With such oil hole 55 that is arranged close to the attaching part (53A or 53B), it is also possible to discharge the cutting oil CO directly to the flank of the cutting edge of the cutting insert 10, although the position of the oil hole 55 is not particularly limited to the above. In an example, the oil hole 55 in this embodiment is arranged on a bottom surface of the shank 53 (on which the attaching parts 53A and 53B are placed) at a portion other than these attaching parts 53A and 53B, which is between the two attaching parts 53A and 53B and relatively close to the side surface of the shank 53 (see FIG. 4).

When the shank 53 is configured as described in the aforementioned embodiments so as to have a stepped portion 53S with a sufficient Z-axis length (width) for arranging a plurality of attaching parts (two attaching parts in this embodiment), it is relatively easy to obtain space for arranging the oil hole 55 by utilizing, for example, an area between such attaching parts.

The above-described embodiments are preferred example embodiments of the present invention; however, the present invention is not limited to those examples and various modifications can be made without departing from the gist of the present invention. For example, although the above-described embodiments describe the shank 53 having a stepped portion 53S (see FIG. 5A, etc.), this is merely an example of a suitable structure for arranging the head attaching part (53A, 53B) at an off-center position. What is necessary is to make the attaching part (53A, 53B) off-center as appropriate, and thus, the shank 53 does not necessarily have to have a stepped portion 53S. For instance, even when the shank 53 does not have a stepped portion but is instead a rectangular prism, it is obviously possible to arrange an attaching part (53A, 53B) off-center as appropriate (see FIG. 5B).

The present invention is suitably applied generally to cutting tools for lathe machining, and particularly to a shank of a head-replaceable tool, etc. for an automatic lathe.

What is claimed is:

1. A shank of a head-replaceable cutting tool, comprising at least one attaching part to which a head is attached, wherein the at least one attaching part is arranged at an off-center position relative to an axis of the shank.

2. The shank according to claim 1, wherein the axis of the shank corresponds to an axis that extends in a longitudinal direction of the shank, and the attaching part for the head is arranged so as to be off-center in a direction perpendicular to the axis.

3. The shank according to claim 1, wherein the attaching part is arranged so as to be off-center along a feeding direction of a workpiece relative to an axis that extends in a longitudinal direction of the shank, the workpiece being an object to be cut.

4. The shank according to claim 1, comprising a plurality of attaching parts.

5. The shank according to claim 4, wherein the plurality of attaching parts are arranged along a direction in which the at least one attaching part is arranged off-center.

6. The shank according to claim 4, wherein one of the plurality of attaching parts is arranged at a position on the axis of the shank.

7. The shank according to claim 1, comprising an oil hole provided close to the attaching part, the oil hole configured to discharge cutting oil toward the head attached to the attaching part.

8. The shank according to claim 7, wherein the oil hole is provided on a surface where the attaching part is arranged, at a portion other than the attaching part.

9. A cutting tool comprising a shank according to claim 1.
